(19) United States
(12) Patent Application Publication
(10) Pub. No.: US 2007/0090621 A1
(43) Pub. Date: Apr. 26, 2007

(54) Vehicle suspension with shared pivot axis

(75) Inventor: David L. Vigen, Thief River Falls, MN (US)

Correspondence Address: BLACK LOWE & GRAHAM, PLLC, 701 FIFTH AVENUE, SUITE 4800, SEATTLE, WA, 98104, US

(73) Assignee: Arctic Cat Inc.

(21) Appl. No.: 11/255,057

(22) Filed: Oct. 20, 2005

(51) Int. Cl. B60G 9/02; B62D 7/16; B60G 7/00

(52) U.S. Cl. 280/124.134; 280/93.51; 280/124.111; 280/124.113

(57) ABSTRACT

A suspension includes a longitudinal pivot axle coupled to a vehicle frame. First and second A-arms are rotationally coupled to and extend outwardly from the pivot axle. Third and fourth arms are rotationally coupled to and outwardly extending from the vehicle frame at first and second mounting positions, respectively. The first and third arms are configured to be distally coupled to a first wheel. The second and fourth arms are configured to be distally coupled to a second wheel. In one particular embodiment, the suspension further includes a tie-rod steering assembly. The tie-rod steering assembly is rotationally coupled to the vehicle frame at a third mounting position, and distally coupled to the first wheel. In another particular embodiment, the suspension includes at least one lower spacer, the at least one lower spacer adapted to be positioned on the pivot axis and to provide caster adjustment of any of the first and second arms. In yet another particular embodiment, the suspension system includes at least one upper spacer, the at least one upper spacer adapted to be positioned between any of the third and fourth arms and the vehicle frame structure and to provide caster adjustment of any of the third and fourth arms.

### FIELD OF THE INVENTION

This invention relates generally to suspension systems and, more specifically, to an independent adjustable caster suspension with a lower, shared pivot axis.

### BACKGROUND OF THE INVENTION

Independent suspensions for all-terrain and other off-road vehicles typically include lower and upper arms extending laterally from a vehicle frame to a wheel assembly. The inner ends of the arms are coupled to the vehicle frame at different mounting points in such a manner to facilitate vertical rotational movement at a fixed caster angle to accommodate changes in the wheel positioning at the outer ends of the arms as the wheels encounter variable terrain.

The steering assembly for the wheel typically comprises a steering wheel or handle bars attached to a steering shaft with a steering arm affixed to the lower end thereof. A tie rod extends from the steering arm to the wheel to transfer the desired movement from the steering shaft to the wheel.

The tie rod must move up and down with the suspension arms in a manner to allow the operator to steer the vehicle despite changes in the wheel positioning due to suspension motion. Suspension-induced steering action (“bump steer”) sometimes results when one wheel encounters a terrain feature. Suspension motion also may cause changes in wheel camber as the suspension moves through its travel arc, especially with short suspension arms and large suspension travel that is common with all-terrain vehicles.

Further, caster angle setting may be desirable for specific operating conditions or manufacturing variability.

Although workable steering systems have been developed for all-terrain vehicles, adjustable, light-weight, robust, and cost-effective suspension and steering systems are needed.

### SUMMARY OF THE INVENTION

The present invention relates to independent suspension systems and more specifically, to independent suspension systems having “A”-frame arm assemblies (“A-arms”). In one embodiment, the suspension system includes a pivot axle and a first, second, third, and fourth arms. Preferably, the first and second arms are identical A-arms—the second arm being oriented approximately 180 degrees from the first arm. The pivot axle is coupled to a vehicle frame. The first and second arms are rotationally coupled to the pivot axle and outwardly extend therefrom. In one preferred embodiment, the first and second arms are rotationally coupled to the pivot axle using cylindrical sleeves. In this embodiment the sleeves may alternatively be separated from the pivot axle using a bushing, a bearing, an additional sleeve, or other type of similar device. The third and fourth arms are rotationally coupled to the vehicle frame at first and second mounting positions, respectively, and also outwardly extend therefrom.

In a further embodiment, spacers are positioned on the pivot axle and/or on the first and/or second mounting positions to allow caster adjustments. The first and third members are distally coupled to a first wheel and the second and fourth members are coupled to an opposing second wheel.

In a further aspect of the invention, the system includes at least one tie rod steering assembly. The tie rod steering assembly is rotationally coupled to a steering arm at the lower end of a steering shaft (a third mounting position) and extends outwardly therefrom to couple to the first wheel to steer the wheel. In one particular embodiment, the tie rod is mounted to the steering arm transversely between the third arm (e.g., upper arm) mounting position and the first arm (e.g., lower arm) mounting position (pivot axle). In another embodiment, the system includes a second tie rod steering assembly. The second tie rod steering assembly is similarly rotationally coupled to the steering arm and extends outwardly therefrom to couple to the second wheel. In one particular embodiment, the second tie rod is mounted to the steering arm transversely between the fourth arm (e.g., upper arm) mounting position and the second arm (e.g., lower arm) mounting position (pivot axle).

### BRIEF DESCRIPTION OF THE DRAWINGS

Preferred and alternative embodiments of the present invention are described in detail below with reference to the following drawings.

FIG. 1 is a front isometric view of a system including a frame suspended by a suspension system relative to front wheel mounting assemblies, in accordance with an embodiment of the invention;

FIG. 2 is a bottom plan view of a system including a frame suspended by a suspension system relative to front wheel mounting assemblies, in accordance with an embodiment of the invention;

FIG. 3 is a front elevational view of a system including a frame suspended by a suspension system relative to front wheel mounting assemblies, in accordance with an embodiment of the invention;

FIG. 4 is an upper isometric view of a system including a lower component of a suspension system for suspending a frame relative to wheels, in accordance with an embodiment of the invention;

FIG. 5 is an isometric partial view of a system including a lower component of a suspension system for suspending a frame relative to wheels, in accordance with an embodiment of the invention;

FIG. 6 is a side-elevational partial view of a system including an upper component of a suspension system for suspending a frame relative to wheels, in accordance with an embodiment of the invention;

FIG. 7 is a cross-sectional front elevational view of a lower pivot axle and left lower arm; and

FIG. 8 is a cross-sectional side-elevational view of a lower pivot axle between forward and rearward frame members.

### DETAILED DESCRIPTION OF THE PREFERRED EMBODIMENT

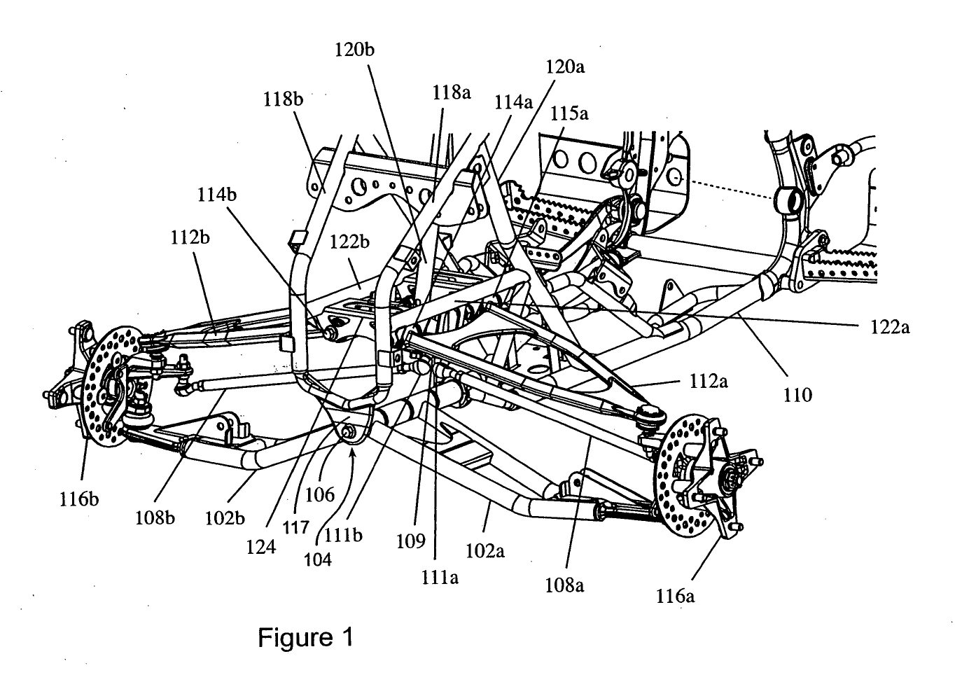

FIG. 1 is a front isometric view of a suspension system secured between a frame and front wheel mounting assemblies of an all-terrain vehicle (“ATV”), in accordance with the preferred embodiment of the invention. The ATV includes a frame 110; a left lower arm 102a; a right lower arm 102b; a left tie rod steering assembly 108a; a right tie rod steering assembly 108b; a left upper arm 112a; a right upper arm 112b; a left wheel attachment assembly 116a; a right wheel attachment assembly 116b; and a lower pivot axle 104.

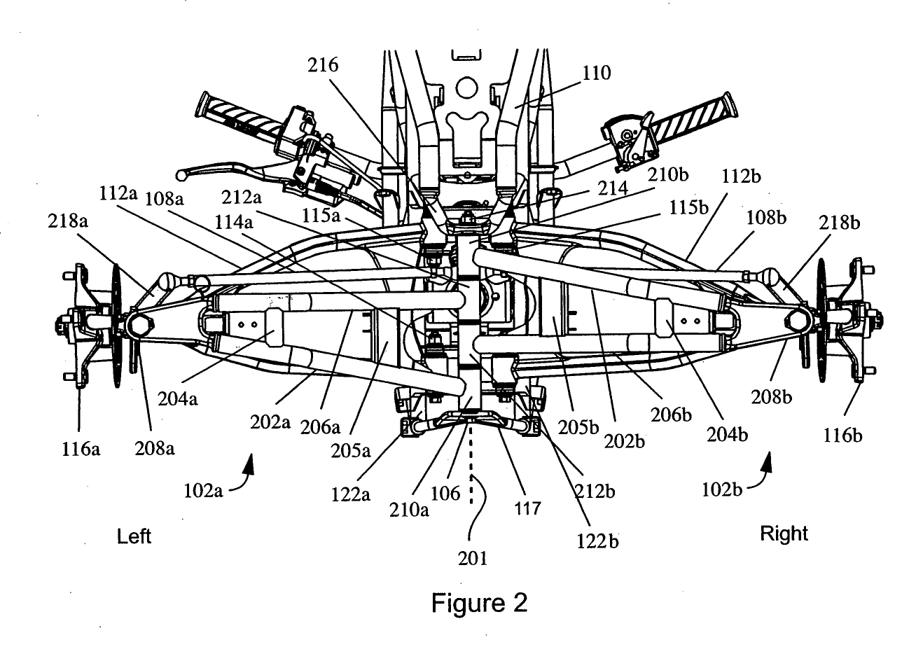

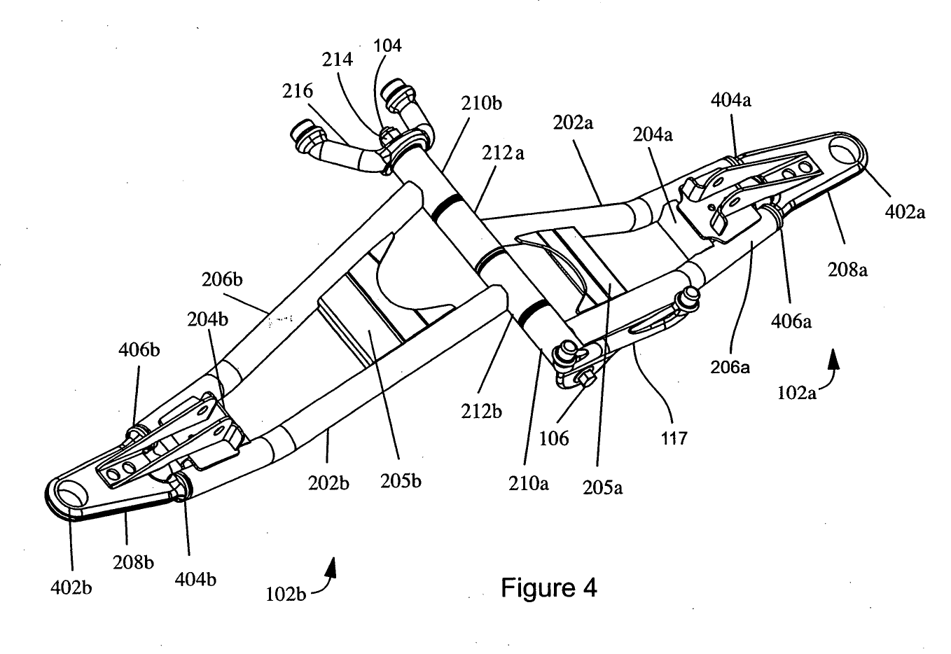

The shared lower pivot axle 104 extends between portions of the frame 110 and is adapted to receive the left and right lower arms 102a, 102b. Preferably, the lower pivot axle 104 is a longitudinal member. More specifically, the lower pivot axle 104 is secured to the frame 110 between a “Y”-shaped brace 117 and a rear coupler 216 (see FIGS. 2 and 4). Brace 117 branches outward and upward to a left forward frame member 118a and a right forward frame member 118b. Rear coupler 216 branches rearward and outward to left rearward frame member 120a and right rearward frame member 120b. The left and right forward frame members 118a, 118b are approximately parallel and extend approximately vertically to their attachment with brace 117, which in turn couples to the lower pivot axle 104, preferably near a head 106 of axle bolt 104. Similarly, the left and right rearward frame members 120a, 120b are approximately parallel and extend approximately vertically to coupler 216 near a nut 214 at the rearward end of axle 104 (FIGS. 2 and 4). A left cross support member 122a extends approximately horizontally and couples to the left forward frame member 118a and the left rearward frame member 120a (FIG. 1). Similarly, a right cross support member 122b extends approximately horizontally and couples to the right forward frame member 118b and the right rearward frame member 120b. A plurality of additional cross support members 124 extend approximately horizontally and couple the left cross support remember 122a and the right cross support member 122b. Thus, the left and right forward and rearward frame members 118a, 120a, 118b, 120b support the lower pivot axle 104 with brace 117 and coupler 216 to suspend the frame 110 relative to wheels (not shown).

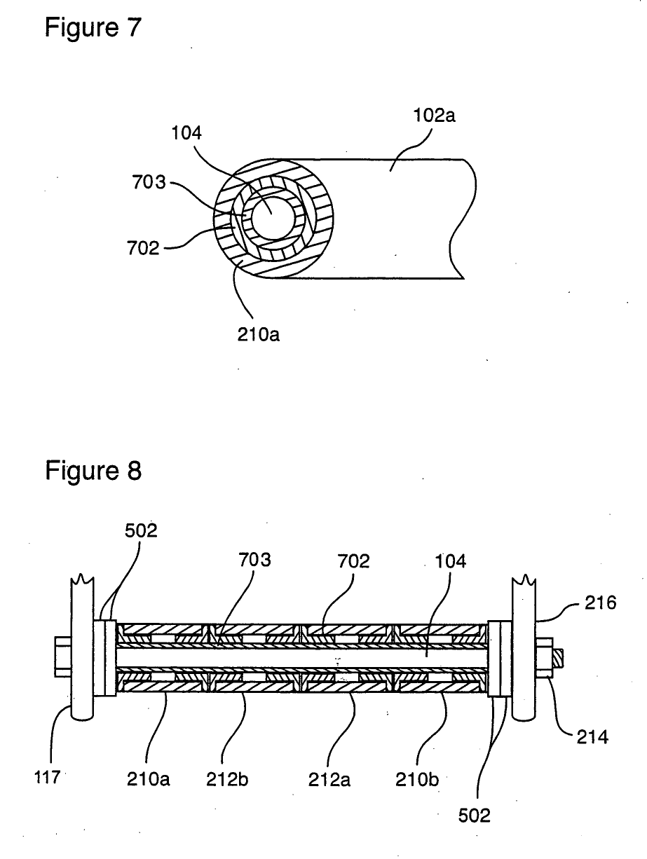

The left and right lower arms 102a, 102b slidably mount the shared lower pivot axle 104 through cylindrical sleeves and are adapted to rotate about the lower pivot axle 104 and an inner sleeve 703 (see FIG. 7). Cylindrical bushings (see FIG. 8) are placed between the sleeves and the pivot axle. The left and right lower arms 102a, 102b are secured between brace 117 and coupler 216 with axle 104, including head 106, nut 214, and sleeve 703 (illustrated in FIGS. 2, 7, and 8). The left and right lower arms 102a, 102b extend laterally in opposing directions from the lower pivot axle 104 and are adapted to receive the left and right wheel attachment assemblies 116a, 116b, respectively. The left upper arm 112a rotationally mounts to the left cross support member 122a and additional cross support members 124 at left forward and rearward mounting positions 114a and 115a. The right upper arm 112b rotationally mounts to the right cross support member 122b and additional cross support members 124 at right forward mounting position 114b and right rearward mounting position 115b. The left upper arm 112a extends laterally from the left forward and rearward mounting positions 114a, 115a and is adapted to receive the left wheel attachment assembly 116a. The right upper arm 112b extends laterally from the right forward mounting position 114b and the right rearward mounting position 115b and is adapted to receive the right wheel attachment assembly 1116b.

The left and right tie rod steering assemblies 108a, 108b laterally extend in opposing directions from a left and right ball socket pivots 111a, 111b to couple with the left and right wheel attachment assemblies 116a, 116b. The left and right ball socket pivots 111a, 111b are coupled to a steering arm 109 (in turn coupled to a vehicle steering assembly, such as handle bars or steering wheel) to cause the left and right tie rod steering assemblies 108a, 108b to translate.

FIG. 2 is a bottom plan view of the frame and suspension described above. This view illustrates the left and right tie rod steering assemblies 108a, 108b hingedly attached to left and right levers 218a, 218b at the distal ends. The left and right levers 218a, 218b are coupled to the left and right wheel attachment assemblies 116a, 116b. Thus, force exerted by the left and right tie rod steering assemblies 108a, 108b to the left and right wheel attachment assemblies results in rotational movement of the left and right wheel attachment assemblies.

The left lower arm 102a is comprised of a first member 202a, a second member 206a, a first lower arm cross-member 204a, a second lower arm cross-member 205a, a wheel assembly receiving end 208a, a first lower pivot axle mount 210a, and a second lower pivot axle mount 212a. The first member 202a and the second member 206a are operatively coupled to the first lower pivot axle mount 210a and the second lower pivot axle mount 212a, respectively. The first member 202a and the second member 206a extend laterally from the first lower pivot axle mount 210a and the second lower pivot axle mount 212a to converge at the wheel assembly receiving end 208a. The first member 202a and the second member 206a are medially connected by the first lower arm cross-member 204a distal to the lower pivot axle and by the second lower arm cross-member 205a proximate to the lower pivot axle. The first and second lower pivot axle mounts 210a, 212a are cylindrical, hollow sleeves for slidably receiving the lower pivot axle in a manner that permits the left lower arm 102a to rotate about the lower pivot axis. Bearings or bushings are preferably disposed in the space between the lower pivot axle and the inside walls of the first and second lower pivot axle mounts 210a, 212a. The left lower arm 102a is adapted to rotate about the lower pivot axle. The wheel assembly receiving end 208a is adapted to couple with the left wheel attachment assembly 116a. In this regard, approximately vertical movement of left wheel attachment assembly and wheel (not shown) is facilitated by the coupling of the left lower arm 102a with the lower pivot axle.

In this embodiment, the right lower arm 102b is identical to the left lower arm 102a. The position of the right lower arm 102b is simply swung about a vertical axis from the position of the left arm 102a such that member 202b is rearward of member 206b, for example. The lengths and arrangement of the members is such that the wheel assembly receiving ends 208a, 208b position the wheel assemblies 116a, 116b opposite each other at the same longitudinal position along the frame 110. Note that the arms 102a, 102b are coupled to the lower pivot axle in a staggered formation whereby the first lower pivot axle mount 210a is proximate to the forward brace 117 and is followed by the second lower pivot axle mount 212b, the second lower pivot axle mount 212a, and the first lower pivot axle mount 210b. This arrangement reduces part counts and thereby the cost of the vehicle, besides having the advantages of longer A-arms and reduced bump steer.

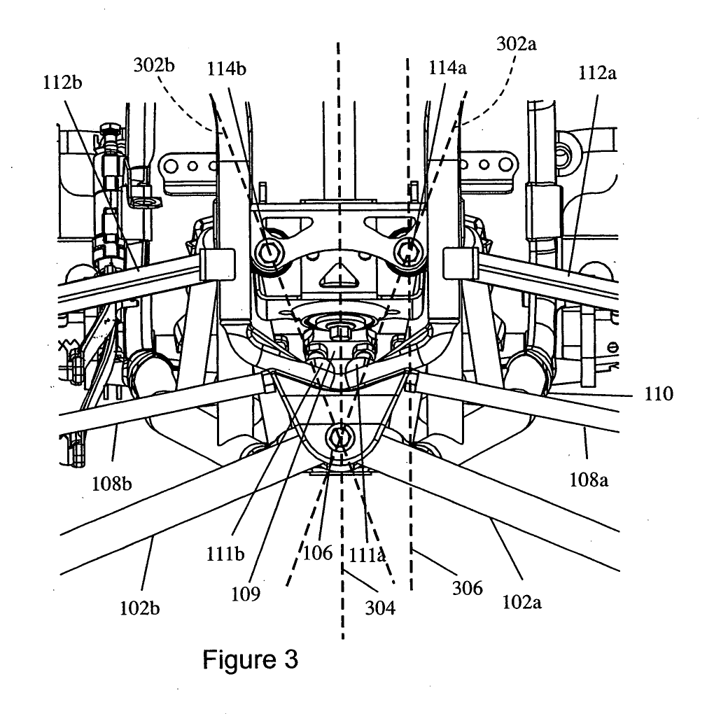

FIG. 3 is a front elevational view of the connections of the suspension arms to the frame. Note in this figure the relative placements of the pivot mounting locations of the upper and lower A-arms 102a, 102b, 112a, 112b as well as tie rods 108a, 108b. When the vehicle is steered in a straightforward position (i.e., a centered position), the left ball socket pivot 111a is approximately between a first plane 306 that includes the left forward mounting position 114a and a second plane 304 that includes the lower pivot axle 104. In the preferred embodiment, the right ball socket pivot 111b is arranged in substantially the same way. The left and right tie rod steering assemblies 108a, 108b are coupled to the left and right ball socket pivots 111a, 111b. At least when the steering is centered, the left ball socket pivot 111a is operatively positioned approximately in a plane 302a with (1) the lower pivot axle (hidden from view) from which the left and right lower arms 102a, 102b are coupled and (2) the left forward and rearward mounting positions 114a, 115a (FIG. 2). Similarly, at least when the steering is centered, the right ball socket pivot 111b is operatively positioned approximately in a plane 302b with (1) the lower pivot axle from which the left and right lower arm 102a, 102b is coupled and (2) the right forward and rearward mounting positions 114b, 115b (FIG. 2). This configuration contributes to a reduction in suspension-induced steering action (i.e., bump steer).

FIG. 4 shows the lower arms 102a, 102b along with axle 104, brace 117, and coupler 216 separate from the remainder of the vehicle. The left and right lower arms 102a, 102b are rotationally coupled to the lower pivot axle as previously described in FIGS. 1-3. FIG. 4 also illustrates left and right receiving apertures 402a, 402b for coupling with the left and right wheel attachment assemblies 116a, 116b (FIG. 1), respectively. Also, the first member 202a and the second member 206a are coupled to the wheel assembly receiving end 208a by inserting longitudinal extensions of the wheel assembly receiving end 208a into the hollow receivers 404a and 406a of the first and second members 202a, 206a, respectively. In this embodiment, the right lower arm 102b includes the same configuration. The rear coupler 216 and front brace 117 are adapted to secure the lower pivot axle with the frame 110 (not shown).

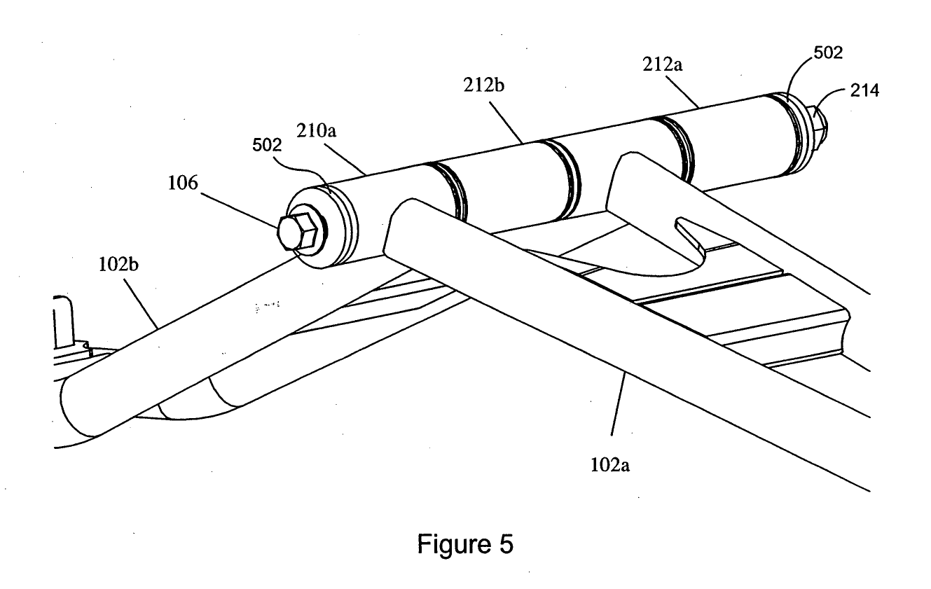

FIG. 5 is an isometric partial view of the lower arms 102a, 102b coupled to the axle 104, 106, but with the brace 117 and coupler 216 removed. This illustration shows the lower pivot axle mounts 210a, 212b, 212a, and 212b rotationally coupled to the lower pivot axle in an alternating or staggered arrangement.

The lower pivot axle mounts 210a, 210b, 212a, 212b are operatively sized to permit the further inclusion of lower spacers 502 of various widths. The lower spacers 502 are optionally positioned singularly or multiply adjacent to the forward end of pivot axle mount 210a or adjacent the rearward end of mount 212a. The lower spacers 502 permit adjustable degrees of caster changes for the left and right lower arms 102a, 102b. The preferred positioning of the spacers 502 is further discussed below in connection with FIG. 8.

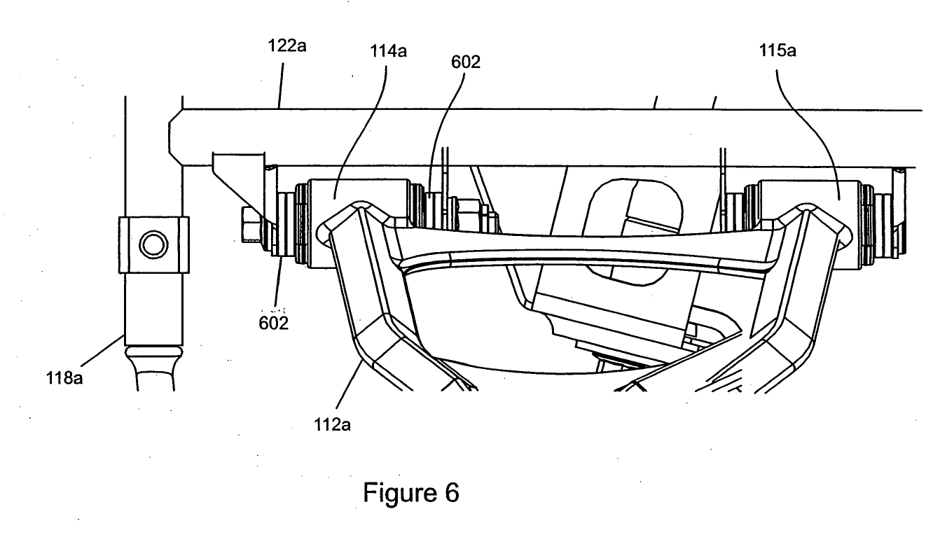

FIG. 6 further clarifies the connection of upper arms 112a, 112b to frame 110. The left upper arm 112a is mounted on the frame 110 at the left cross support member 122a at the left forward mounting position 114a and the left rearward mounting position 115a. In this embodiment, upper spacers 602 of various widths are disposed between the left forward mounting position 114a and the mounting tabs of the frame 110 to permit adjustable degrees of caster changes for the left upper arm 112a. The upper spacers 602 are also preferably disposed between the frame mounting tabs on either or both sides of the rear arm mounting position 115a. Similarly, the upper spacers 602 are optionally disposed at similar locations on the right upper arm 112b (not shown). In a preferred embodiment four spacers 602 are used at each arm mounting location, with two on each side. The spacers may be shifted to one side or the other to change the caster angle of the attached wheel. However, as there is a fixed arm mounting length, the combined spacer width is the same no matter how the spacers may be shifted in any given caster angle set up.

FIG. 7 further illustrates the arrangement of the bushings 702 within the pivot axle mount 210a of arm 102a, in accordance with an embodiment of the invention. In the preferred embodiment, an inner sleeve 703 circumscribes the lower pivot axle 104 and the bushings 702 are disposed between the inner sleeve 703 and the pivot axle mount 210a. Accordingly, the left and right lower arms 102a, 102b slidably mount the lower pivot axle 104, the inner sleeve 703, and the bushings 702 and are adapted to rotate about the lower pivot axle 104 and the inner sleeve 703.

FIG. 8 shows cut-away detail of the lower pivot axle arrangement. The left lower arm includes the first and second lower pivot axle mounts 210a, 212a and the right lower arm includes the first and second lower pivot axle mounts 210b, 212b. The lower pivot axle mounts 210a, 212a, 210b, 212b are rotationally coupled to the lower pivot axle 104 and the inner sleeve 703. The bushings 702 are positioned between the lower pivot axle mounts 210a, 212a, 210b, 212b and the inner sleeve 703. The lower spacers 502 are positioned singularly or multiply on the lower pivot axle 104 between the lower arms and the brace 117 or the coupler 216.

While the preferred embodiment of the invention has been illustrated and described, as noted above, many changes can be made without departing from the spirit and scope of the invention. For example, in one embodiment, the entire system described in FIG. 1 may be inverted whereby the lower pivot axle 104 is located in the upper position and the left and right upper arms 112a, 112b are located in the lower position. In another embodiment the left and right lower arms 102a, 102b and left and right upper arms 112a, 112b are of various sizes, shapes, materials, and construction. In another embodiment, the left and right lower arms 102a, 102b and the left and right upper arms 112a, 112b are of different sizes, shapes, materials, and construction from one another. In yet another embodiment, the left and right lower arms 102a, 102b rotationally couple to the lower pivot axle 104 using a hinge assembly or any other known method of permitting rotation about a central axle. In a further embodiment, the first and second lower pivot axle mounts 210, 212 of either of the lower arms 102a, 102b are combined into a single mounting section or are separated into three or more mounting sections and are coupled to the lower pivot axle 104 in any suitable formation (e.g. non-staggered). In yet a further embodiment, the left and right upper arms 112a, 112b are each coupled to the frame 110 using only a single mounting section or two or more mounting sections. In alternate embodiments bolt attachments are replaced by any known fastener including pins, welding, or simply unitary construction. In another embodiment, the frame 110 supports the lower pivot axle 104 in fewer or additional places and is not limited to any particular form. Accordingly, the scope of the invention is not limited by the disclosure of the preferred embodiment. Instead, the invention should be determined by reference to the claims that follow.

1. A suspension for a vehicle for travel over varying terrain, the suspension coupled between a vehicle frame structure and first and second terrain-engaging members, the suspension comprising:
a pivot axle extending along a pivot axis, the pivot axis extending in a generally longitudinal direction relative to the frame structure;
first and second arms, each arm having first and second end portions, each of the first end portions coupled to a respective one of the terrain-engaging members, the second end portions rotationally coupled to the pivot axle,
the second arm extending outwardly from the pivot axle in a direction opposite from the first arm;
first and second support members located above the pivot axle and coupled to the vehicle frame structure;
a third arm rotationally coupled to and outwardly extending from the first support member at a first mounting position; and
a fourth arm rotationally coupled to and outwardly extending from the second support member at a second mounting position,
wherein the first and third arms are distally coupled to the first terrain-engaging member and the second and fourth arms are distally coupled to the second terrain-engaging member.

2. The suspension of claim 1 further comprising:
a steering arm; and
a tie rod steering assembly rotationally coupled to the vehicle frame structure at a third mounting position located on the steering arm, and further coupled to the first terrain-engaging member.

3. The suspension of claim 2, wherein the third mounting position is between a first plane including the first mounting position and a second plane including the pivot axis.

4. The suspension of claim 1, wherein the first and second arms are rotationally coupled to the pivot axle with cylindrical sleeves.

5. The suspension of claim 1, wherein the first and second arms interchangeable.

6. The suspension of claim 1, further comprising:
at least one lower spacer positioned on the pivot axle to provide a caster adjustment for either of the first and second arms.

7. The suspension of claim 1, further comprising:
at least one upper spacer positioned between either of the third or fourth arms and the vehicle frame structure and to provide a caster adjustment for either of the third or fourth arms.

8. The suspension of claim 4, wherein the pivot axle and the cylindrical sleeves are separated by a bushing or a bearing.

9. A suspension system, comprising:
a pivot axle coupled to a vehicle frame;
first and second arms each rotationally coupled to and extending outwardly from the pivot axle, the first arm extending outwardly from the pivot axle in a direction opposite from the second arm;
third fourth arms, the third arm rotationally coupled to and outwardly extend from the vehicle frame at a first mounting position located above the pivot axle, the fourth arm rotationally coupled to and outwardly extend from the vehicle frame at a second mounting position located above the pivot axle;
a first tie rod steering-assembly rotationally coupled to the vehicle frame at a third mounting position; and
a second tie rod steering assembly rotationally coupled to the vehicle frame at a fourth mounting position,
wherein the first and third arms and the first tie rod assembly are distally coupled to a first wheel, and wherein the second and fourth arms and the second tie rod assembly are distally coupled to a second wheel.

10. The suspension system of claim 9, wherein the third mounting position is between a first plane including the first mounting position and a second plane including the pivot axle.

11. The suspension system of claim 9, wherein the first and second arms are rotationally coupled to the pivot axle with cylindrical sleeves.

12. The suspension system of claim 9, wherein the first and second arms each have an A-shape and are interchangeable with one another.

13. The suspension system of claim 9, further comprising:
at least one lower spacer positioned on the pivot axle to provide a caster adjustment for at least one of the first arm or the second arm.

14. The suspension system of claim 9, further comprising:
at least one upper spacer positioned between for at least one of the third arm or the fourth arm and the vehicle frame to provide a caster adjustment of at least one of the third arm or the fourth arm.

15. The suspension system of claim 9, wherein the third mounting position is a steering arm.

16-20. (canceled)

21. A suspension system for a vehicle having a vehicle frame, comprising:
first support means for rotationally coupling a first wheel attachment member to the vehicle frame, the first support means having a proximal end including two longitudinally spaced axle mounts, rotationally coupled to the vehicle frame through a pivot axle, and the first support means having a distal end coupled to the first wheel attachment member;
second support means for rotationally coupling a second wheel attachment member to the vehicle frame, the second support means having a proximal end including two longitudinally spaced axle mounts rotationally coupled to the pivot axle, and the second support means having a distal end coupled to the second wheel attachment member, wherein the second support means extends from the pivot axle in a direction opposite to the first support means;
third support means cooperating with the first support means for coupling the first wheel attachment member to the vehicle frame, the third support means coupled to the vehicle frame above the pivot axle and coupled to the first wheel attachment member above the distal end of the first support means; and
fourth support means cooperating with the second support means for coupling the second wheel attachment member to the vehicle frame, the fourth support means coupled to the vehicle frame above the pivot axle and coupled to the second wheel attachment member above the distal end of the second support means.

22. The suspension system of claim 21, wherein the two mounts rotationally coupled to the pivot axle of both the first and second support means are rotationally coupled to the pivot axle with cylindrical sleeves.

23. The suspension system of claim 21, further comprising means for adjusting an amount of caster for at least one of the first, second, third, or fourth support means.

24. The suspension system of claim 21, further comprising:
first steering means coupled to the vehicle frame and the first wheel attachment member; and
second steering means coupled to the vehicle frame and the second wheel attachment member.

25. The suspension system of claim 21, wherein the first support means and the second support means are interchangeable.

26. The suspension system of claim 21, wherein the pivot axle is located in a forward portion of the vehicle.

27. The suspension system of claim 21, further comprising:
coupling means for securing the pivot axle to the vehicle frame.

28. The suspension system of claim 27, wherein the coupling means includes a Y-shaped brace.
